(19) United States
(12) Patent Application Publication
(10) Pub. No.: US 2008/0175225 A1
(43) Pub. Date: Jul. 24, 2008

(54) JUST-IN-TIME CALL REGISTRATION FOR MOBILE CALL TO VOIP DEVICE

(76) Inventors: Lon-Chan Chu, Redmond, WA (US); Vinay Gupta, Sammamish, WA (US); Kevin Liu, Kirkland, WA (US); Quentin Miller, Sammamish, WA (US); Fiona O'Leary, Seattle, WA (US)

Correspondence Address: VIERRA MAGEN/MICROSOFT CORPORATION, 575 MARKET STREET, SUITE 2500, SAN FRANCISCO, CA, 94105, US

(21) Appl. No.: 11/624,576

(22) Filed: Jan. 18, 2007

(51) Int. Cl. H04L 12/28

(52) U.S. Cl. 370/352

(57) ABSTRACT

A method for establishing a hybrid voice session between a mobile device and a VoIP device is disclosed. A caller using a mobile device in a mobile network initiates a request for a voice session by clicking on a virtual identifier, e.g. an email address, provided for the callee in an address book on the caller's mobile device. If the callee is online, then the request is enabled. In one embodiment, the request is enabled by creating a call registration record using a mobile data network. In another embodiment, the request is enabled by having the caller interact with an IVR system. In yet another embodiment, a caller can interact with the IVR system from any type of telephone device. The callee is notified regarding the voice session, and if accepted, the hybrid voice session is established via a voice channel and a VoIP channel.

### BACKGROUND

The advent of Voice Over Internet Protocol (“VoIP”) has added another layer of complexity to the modern world of telephony. VoIP allows users to make telephone calls using a broadband Internet connection instead of conventional wired or wireless telephone lines. Some VoIP services may only allow users to call other people using VoIP devices. However, many services also allow users to call anyone who has a telephone number, including local, long distance, mobile, and international numbers. While some services only work over a computer or a special VoIP phone, other services allow use of a traditional telephone through an adaptor.

Cellular telephone service has also become popular, and most cell phone services permit connections to any other type of telephone service, including cellular, landline, and VoIP services. Protocols for handing off calls from one type of service to another type of service continue to emerge. For example, it is common for a telephone call initiated by a cell phone user to a VoIP device user to be connected as a pure VoIP call. However, the data transport mechanism of the cell phone typically does not have enough bandwidth to sustain high voice quality for a pure VoIP call.

### SUMMARY

The present disclosure describes methods for establishing a hybrid voice session between a telephone device and a VoIP device.

In one embodiment, a caller on a mobile device initiates a request for a voice session with a callee on a VoIP device by clicking on callee's contact information listed in the mobile device's address book. Because the caller and callee both run an instant messaging application on their devices, the contact information includes a unique virtual identifier for the callee, such as an email address. The virtual identifier includes a presence feature which indicates whether or not the callee is online. If the virtual identifier indicates that the callee is online, then the request will be enabled, and a hybrid voice session will be established using a mobile voice channel and a VoIP voice channel.

In one embodiment, the request is enabled by creating a call registration record using a mobile data network. The record is sent by the mobile device to a call registration server in the VoIP network, and includes attributes of the voice session, including a device identification of the mobile device (the telephone number of the caller's cell phone), the virtual identifier of the callee, and the virtual identifier of the caller. In addition, the record may include the expiration time of the call, and a subject of the call. The caller then dials the VoIP service provider, which retrieves the registration record based on the mobile device identifier. The callee is then identified from the registration record, and a request to notify the callee is generated. The notification request is send to the VoIP device where the callee is signed in, and if the callee accepts the proposed voice session, a mobile voice session is established between the mobile device and a gateway device, and a VoIP voice session is established between the gateway device and the VoIP device.

In one embodiment, the request is enabled by interacting with an interactive voice response (“IVR”) system. The caller dials the VoIP service provider, which accepts the call because the telephone number dialed is a VoIP number. A mobile voice session is then established between the mobile device and a gateway device, and a VoIP voice session also is established between the gateway device and the IVR system. The IVR system sends a ready signal back to the mobile device, and the mobile device then sends the virtual identifier of the callee to the IVR system. Preferably, the mobile device converts the virtual identifier to a series of digits and dials those digits to the IVR system. The VoIP network identifies and locates the callee based on the digits sent to the IVR system, and sends a notification to the VoIP device where callee is signed in regarding the proposed voice session. If the callee accepts the proposed voice session, the VoIP voice session is modified to establish a VoIP voice channel between the gateway device and the VoIP device.

In one embodiment, the request is enabled by interacting with an IVR system. The caller dials the VoIP service provider, which accepts the call because the telephone number dialed is a VoIP number. A first voice session is then established between the telephone device and a gateway device, and a VoIP voice session also is established between the gateway device and the IVR system. The IVR system sends a voice prompt back to the telephone device, and the caller on the telephone device then speaks a command that identifies the intended callee. The VoIP network identifies and locates the callee based on the command sent to the IVR system, then sends a notification to the VoIP device where callee is signed in regarding the proposed voice session. If the callee accepts the proposed voice session, the VoIP voice session is modified to establish a VoIP voice channel between the gateway device and the VoIP device.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a block diagram illustrating one embodiment of a typical computing system.

FIG. 2 is a block diagram illustrating one embodiment of a typical handheld computing device, such as a cellular telephone.

FIG. 3 is a block diagram illustrating an embodiment of a communication system that couples mobile voice and data networks to a VoIP network.

FIGS. 4A and 4B are flowcharts describing a method for establishing a voice session between a mobile device and a VoIP device.

FIG. 5 is a block diagram illustrating an embodiment of a communication system that couples a mobile voice network to a VoIP network.

FIGS. 6A and 6B are flowcharts describing a method for establishing a voice session between a mobile device and a VoIP device using an IVR system.

FIG. 7 is a block diagram illustrating an embodiment of a communication system that couples a telephone voice network to a VoIP network.

FIGS. 8A and 8B are flowcharts describing a method for establishing a voice session between a telephone device and a VoIP device using an IVR system.

### DETAILED DESCRIPTION

The present disclosure describes systems and methods whereby the user of a mobile device (the “caller”) establishes a hybrid voice session with the user of a VoIP device (the “callee”) by clicking on a contact in the contact list of the mobile device. The voice session is considered a hybrid session because it is not a pure VoIP call, i.e., where the voice goes through the IP network to and from both the mobile device and the VoIP device. Instead, the hybrid voice session utilizes multiple media channels, such as the voice channel in the mobile network, and the VoIP channel in the VoIP network, thereby taking advantage of the presence, signaling, and notification infrastructure of the VoIP network. In one embodiment, the data channel of the mobile network is utilized to create a call registration record prior to enabling the hybrid communication channel.

It is now common for many device users, including mobile and VoIP users, to load an instant messaging client application onto their devices in order to have real time chat sessions with others. Popular instant messaging services include: Windows Live Messenger; AOL Instant Messenger, Excite/Pal, Gadu-Gadu, Google Talk, iChat, ICQ, Jabber, Qnext, QQ, Skype, Trillian and Yahoo! Messenger. Such systems require that each user be assigned a unique virtual identifier, such as an email address, that includes a “presence” feature. When a user is logged onto the messaging system, the presence feature will indicate that the user is online. Advantageously, the presence feature may be utilized to facilitate establishing a voice session with a VoIP user that is online.

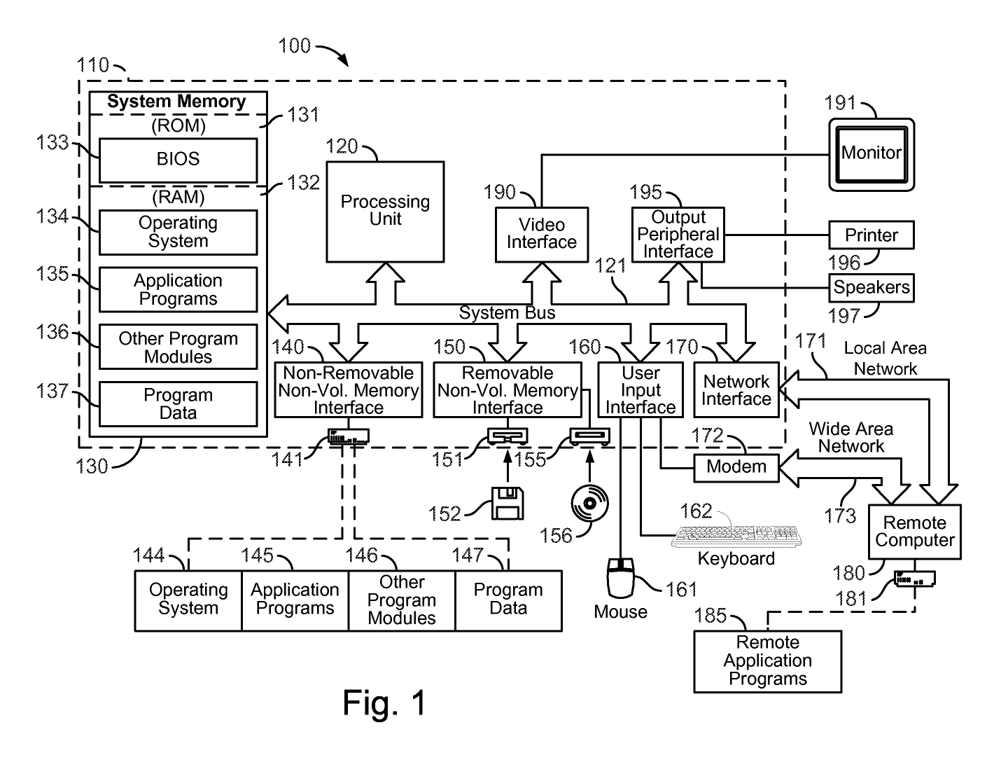

FIG. 1 illustrates one example of a suitable general computing environment 100 that may be used to implement many of the components described herein. For example, computing system 100 can be used to implement most of the devices shown and described below, including VoIP device 304, gateway devices 312, 322, and servers 332, 334, 336, and 338. It should also be noted that computing system 100 is only one example of a suitable computing environment and is not intended to suggest any limitation as to the scope of use or functionality of the technology described herein. Neither should computing system 100 be interpreted as having any dependency or requirement relating to any one or a combination of the components illustrated in the exemplary operating environment 100.

The technologies described herein are operational with numerous general purpose or special purpose computing system environments or configurations. Examples of well known computing systems, environments, and/or configurations that may be suitable for use include, but are not limited to, personal computers, server computers, hand-held or laptop computing devices, personal digital assistants, telephones (wired, wireless, or cellular), multiprocessor systems, microprocessor-based systems, set-top boxes, programmable consumer electronics, network PCs, minicomputers, mainframe computers, distributed computing environments that include any of the above systems or devices, and the like.

The system may be described in the general context of computer-executable instructions, such as program modules, being executed by a computer. Generally, program modules include routines, programs, objects, components, data structures, etc., that perform particular tasks or implement particular abstract data types. The system may also be implemented in distributed computing environments where tasks are performed by remote processing devices that are linked through a communications network. In a distributed computing environment, program modules may be located in both local and remote computer storage media including memory storage devices.

With reference to FIG. 1, an exemplary computing system includes a general purpose computer 110. Components of computer 110 may include, but are not limited to, a processing unit 120 (which can include multiple processors), a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile media, and removable and non-removable media implemented in any method or technology for storage of information, such as computer readable instructions, data structures, program modules or other data. Computer storage media includes, but is not limited to, RAM, ROM, EEPROM, flash memory or other memory technology, CD-ROM, digital versatile disks (“DVD”) or other optical disk storage, magnetic cassettes, magnetic tape, magnetic disk storage or other magnetic storage devices, or any other medium which can be used to store the desired information and which can accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data to program the processor(s) to perform the methods described herein. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 110 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through a output peripheral interface 190.

Computer 110 may operate in a networked environment using logical connections to one or more remote computers, such as a remote computer 180. Remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, computer 110 is connected to LAN 171 through a network interface or adapter 170. When used in a WAN networking environment, computer 110 typically includes a modem 172, network interface or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

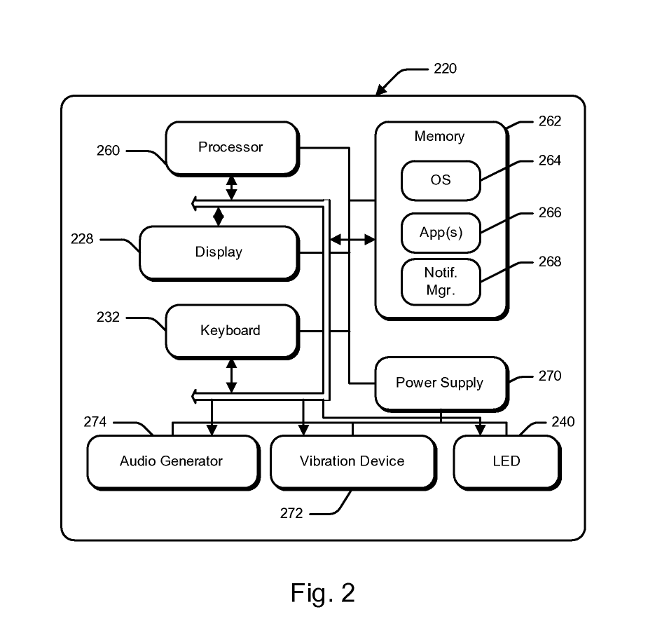

FIG. 2 shows the functional components of typical handheld computing device 220, which include processor 260, memory 262, display 228, and keyboard 232. For example, computing device 220 can be used to implement cell phone 302, as shown and described below. The memory 262 generally includes both volatile memory (e.g., RAM) and non-volatile memory (e.g., ROM, PCMIA cards, etc.). An operating system 264 is resident in the memory 262 and executes on the processor 260.

One or more application programs 266 are loaded into memory and run on the operating system 64. Examples of applications includes email programs, scheduling programs, personal information management (“PIM”) programs, word processing programs, spreadsheet programs, browser program, and so forth. The mobile device 220 includes a notification manager 268 loaded into memory 262, which executes on processor 260. The notification manager handles notification requests from the applications 266.

The mobile device includes a power supply 270, which is preferably implemented as one or more batteries. The power supply might further include an external power source that overrides and/or re-charges the built-in batteries, such as an AC adaptor, or a powered docking cradle.

The mobile device 220 is shown with three types of notification mechanisms: an LED 240, a vibration device 272, and an audio generator 274. These devices are directly coupled to the power supply 270 such that when activated, they remain on for a duration dictated by the notification mechanism even though the processor and other components might be shut down to conserve battery power. For example, the LED 240 is often configured to remain on indefinitely until a user takes action on the notification since the LED is a low power user. The vibration generator and audio generator, however, typically consume more power, and may therefore be configured to turn off after some limited duration, or when other system components are turned off.

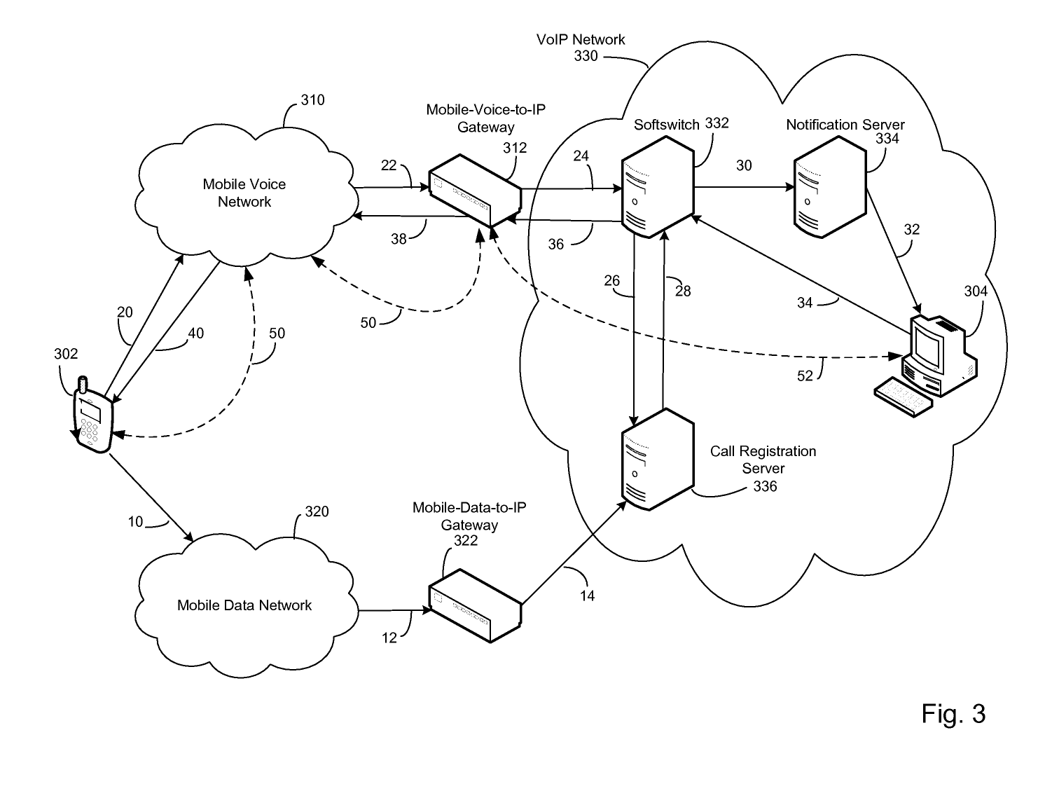

FIG. 3 illustrates one embodiment of a communications system that allows a mobile device to establish a hybrid voice connection with a VoIP device. Call signaling paths are indicated by arrows with solid lines, while voice media paths are indicated by arrows with dashed lines. In this example, the user of a mobile device, i.e., the “caller” with cellular telephone 302, seeks to establish a voice session with a “callee” who is listed as a contact in caller's address book stored on the mobile device. At the relevant time, the callee is using a VoIP device, namely personal computer 304, although the device could be any VoIP capable node, including WiFi device, WiFi telephone, IP telephone, dual-mode mobile telephone, and dual-mode cordless telephone.

The cellular telephone 302 is a conventional mobile device, as generally described in FIG. 2 above, and having two radio interface modules: one for communicating with a mobile voice network 310, and one for communicating with a mobile data network 320. Typically, the mobile voice network 310 is configured to operate in regulated frequency bands, such as 900 MHz, or 1800-2100 MHz (PCS), or both. Likewise, the mobile data network is configured to operate in regulated frequency bands, such as 2.4 GHZ, or 5 GHz, or both, in accordance with the IEEE 802.11 standard. However, other types of network configurations may also be used, including HiperLAN, Bluetooth, HiSWAN, WiMAX, and others. In addition to having an operating system and relevant utilities, cell phone 302 is configured with applications 266, including at least an address book, an instant messaging (“IM”) client, and a mobile network client.

The personal computer (“PC”) 304 is a conventional computing device, as generally described in FIG. 1 above. For the purpose of this disclosure, PC 304 is configured to include at least an IM client and a VoIP client, although these could be integrated into a single client. Other hardware and software are provided and configured as needed.

The mobile voice network 310 is coupled to a VoIP network 330 by a gateway device 312. The mobile voice network 310 is a conventional cellular voice network conforming to applicable telecommunications standards, for example, a second-generation cellular voice network, such as a GSM or CDMA network, or a third-generation cellular voice network, such as a CDMA2000 or UMTS network. Typically, a service provider hosts the network on one or more conventional computing devices, such as device 110, configured to provide relevant server functionality. The gateway device 312 is a conventional computing device, like device 110, that is configured to provide a communication interface between a mobile voice network, such as network 310, and an IP network, such as network 330. The gateway device 312 typically includes all routines necessary for the managing the interface, including compression/decompression, packetization, call routing, and control signaling, for example. The gateway device 312 is operatively coupled to a first server or softswitch 332 in the VoIP network 330. In this embodiment, the softswitch 332 is also coupled to a notification server 334 and a call registration server 336. However, it should be recognized that all three servers could be implemented in a single server device providing all three functions.

The mobile data network 320 is coupled to the VoIP network 330 by second gateway device 322. The mobile data network 320 is a conventional wireless data network conforming to applicable telecommunications standards. Typically, a service provider hosts the network on one or more conventional computing devices configured to provide relevant server functionality. The gateway device 322 is a conventional computing device that is configured to provide a communication interface between a mobile data network, such as network 320, and an IP network, such as network 330. The gateway device 322 typically includes all routines necessary for the managing the interface. The gateway device 322 is operatively coupled to the call registration server 336 of the VoIP network 330.

The VoIP network 330 is a conventional IP network that is hosted by a service provider on one or more conventional computing devices configured to provide relevant server functionality.

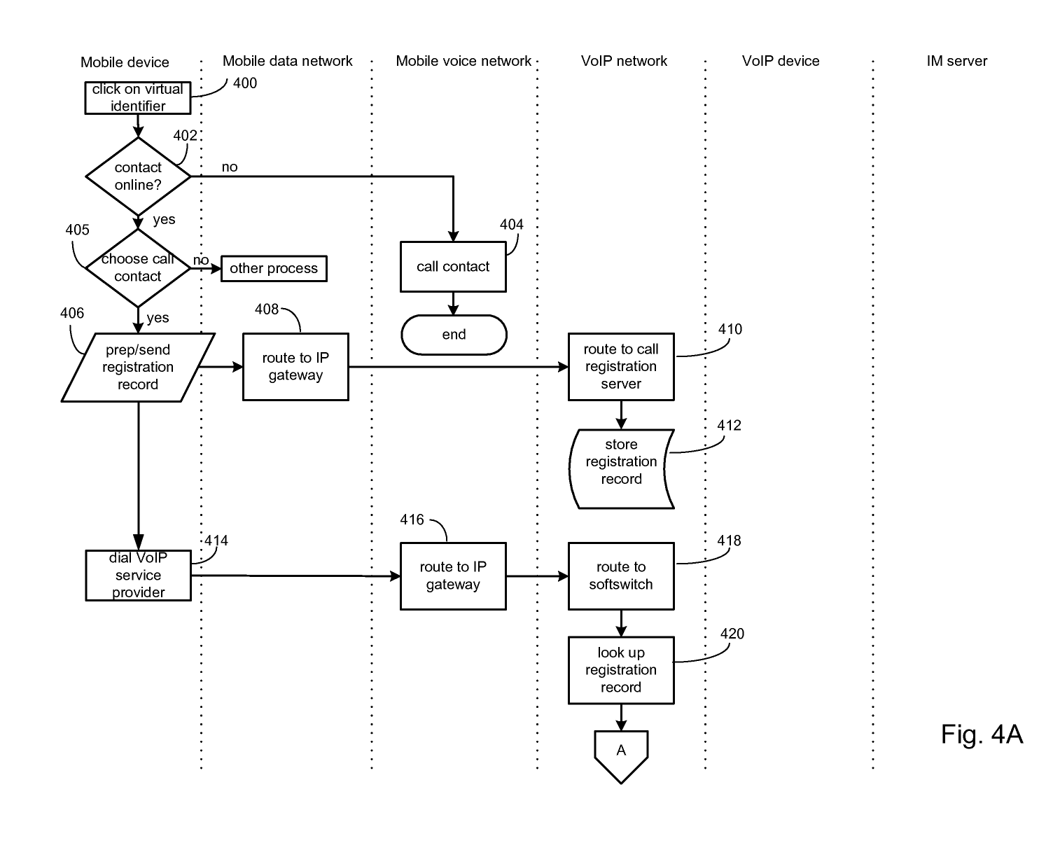

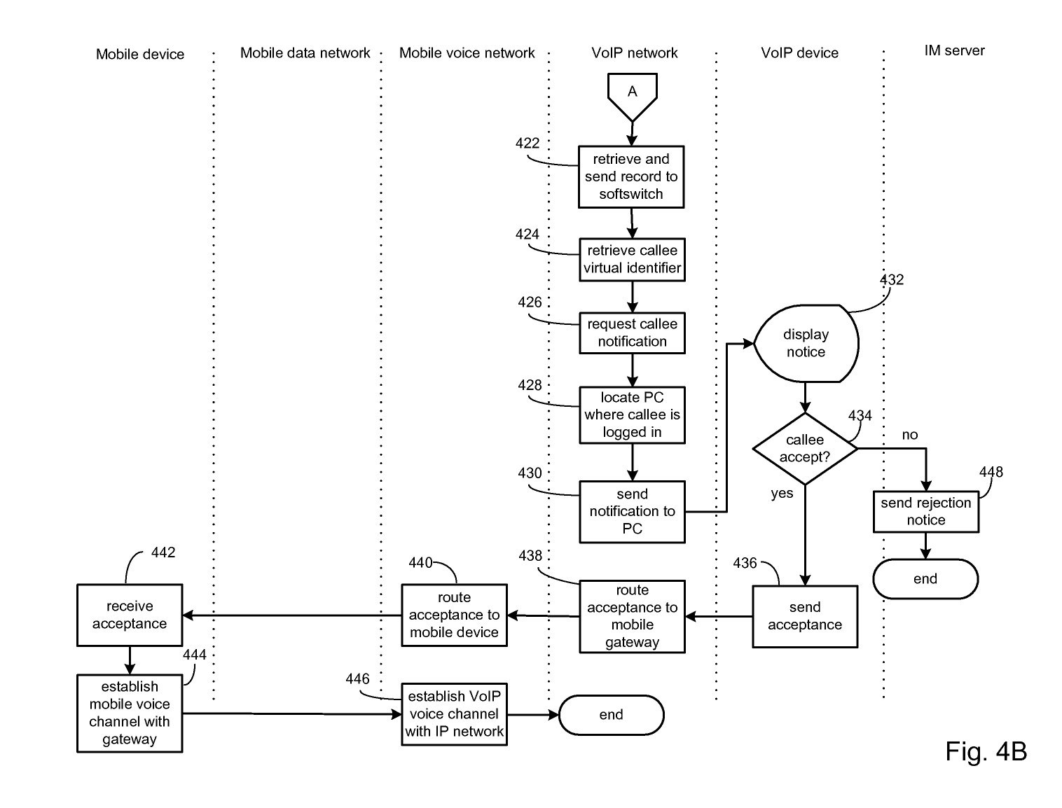

Referring now to FIGS. 4A and 4B, a flow chart illustrates one method of establishing a voice session that is initiated by the caller on cellular telephone 302 to the callee on PC 304. In step 400, the caller opens the address book on cell phone 304, locates the contact listing for the callee, and clicks on the virtual identifier provided for callee. The contact listing may contain several fields, such as name, address, telephone number, etc., but at least one field shows the virtual identifier associated with the callee. The virtual identifier is a unique identifier associated with an individual in the instant messaging network, and it typically includes a “presence feature” that indicates whether or not the individual is currently online. In one embodiment, the virtual identifier is callee's email address, for example, johndoe@hotmail.com.

In step 402, the online status of the callee is polled by the IM client. This step is transparent to the user, and is done periodically by the IM client. Alternatively, the status of the caller's contacts are pushed from the IM presence server and updated whenever the caller is online. Online presence may be indicated in a number of different ways, for example, with a presence indicator, such as a small icon, located next to the virtual identifier. In one embodiment, the icon is green if the user is online, and grey if the user if offline.

If the presence indicator indicates that the contact is online, then in one embodiment, the user is given a means to distinguish among the service features available to IM users. For example, the IM client may cause a pop-up screen to be displayed on cell phone 302 that lists several choices for the IM service: (i) chat with contact; (ii) email contact; and (iii) call contact. If in step 405, the user selects the choice “call contact,” then in step 406, the IM client sends a request to establish a call registration record through the mobile data network 320. This request is indicated by signal path 10 in FIG. 3. The request preferably includes (a) the device identification, i.e., caller ID, of the caller's cell phone 302; (b) the virtual identifier of the callee, e.g. callee's email address; (c) the virtual identifier of the caller; and (optionally) (d) a subject of the call. Since items (a)-(c) of the request are readily identifiable by the address book utility, those items can be automatically incorporated into the request by the address book utility. However, item (d) would have to be manually entered, and a pop-up window can be displayed to the caller asking for this additional information before the request is sent. The call registration record can be configured to expire in a limited amount of time. For example, the expiration time of a call registration record can be configured on the call registration server to have a fixed duration, such as ten seconds.

If the user does not select “call contact” in step 405, then other processing may occur which is outside the scope of this disclosure.

If the contact is determined to be offline in step 404, then the IM client will cause the cell phone 302 to call the telephone number associated with the contact directly in step 404 using the mobile voice network.

In step 408, the mobile data network 320 routes the request from the mobile data network 320 to the gateway 322, as shown by signal path 12 in FIG. 3. In step 410, the gateway 322 routes the request through the VoIP network 330 to call registration server 336 (signal path 14), where the record is created and stored in step 412.

In step 414, the IM client on cell phone 302 dials the telephone number for the VoIP service provider, such as Windows Live, through the mobile voice network 310. This is shown by signal path 20 in FIG. 3. In step 416, the call is routed from the mobile voice network 310 to the gateway 312 (signal path 22). In step 418, the call is routed from the gateway 312 to the softswitch server 332 of the VoIP network 330 (signal path 24) since the telephone number is a VoIP service number managed by the service provider for the VoIP network.

In step 420, the softswitch 332 sends a query to the call registration server 356 to look up the call registration record indexed by the caller ID of the cell phone 302 (signal path 26). In step 422, the call registration server 336 retrieves the record and sends it back to the softswitch server 332 (signal path 28). In step 424, the softswitch server 332 retrieves the callee's virtual identifier from the record, then in step 426, the softswitch sends a request to to the notification server 334 to notify callee (signal path 30). In step 428, the notification server 334 locates the IP address where the callee's virtual identifier is logged in, namely PC 304, and in step 430, the notification server sends a notification to PC 304 (signal path 32). The notification is displayed on PC 304 in step 432 and indicates at least that a voice session is being requested by a caller, for example, by displaying the virtual identifier of the caller or the caller ID of the cell phone 302.

If the callee accepts the call in step 434, then the softphone in PC 304 sends notice of acceptance to the softswitch server 336 in step 436 (signal path 34). In step 438, the softswitch server 336 forwards the call acceptance back to gateway 312 (signal path 36). The gateway 312 in turn forwards the call acceptance to the mobile voice network 310 in step 440 (signal path 38). The cellular telephone 302 receives the call acceptance in step 442 (signal path 40), and a mobile voice session is established (signal path 50) in step 444 with the gateway 312 through the mobile voice network 310. Finally, in step 446, the gateway 312 establishes a VoIP voice session (signal path 52) between the gateway 312 and the PC 304 through the VoIP network 350. Thus, a hybrid voice session is established between cell phone 302 and PC 304 using the mobile voice session and the VoIP voice session. If the callee rejects the call in step 434, the PC 304 sends a notification back to the cell phone 302 indicating that the call was rejected in step 448.

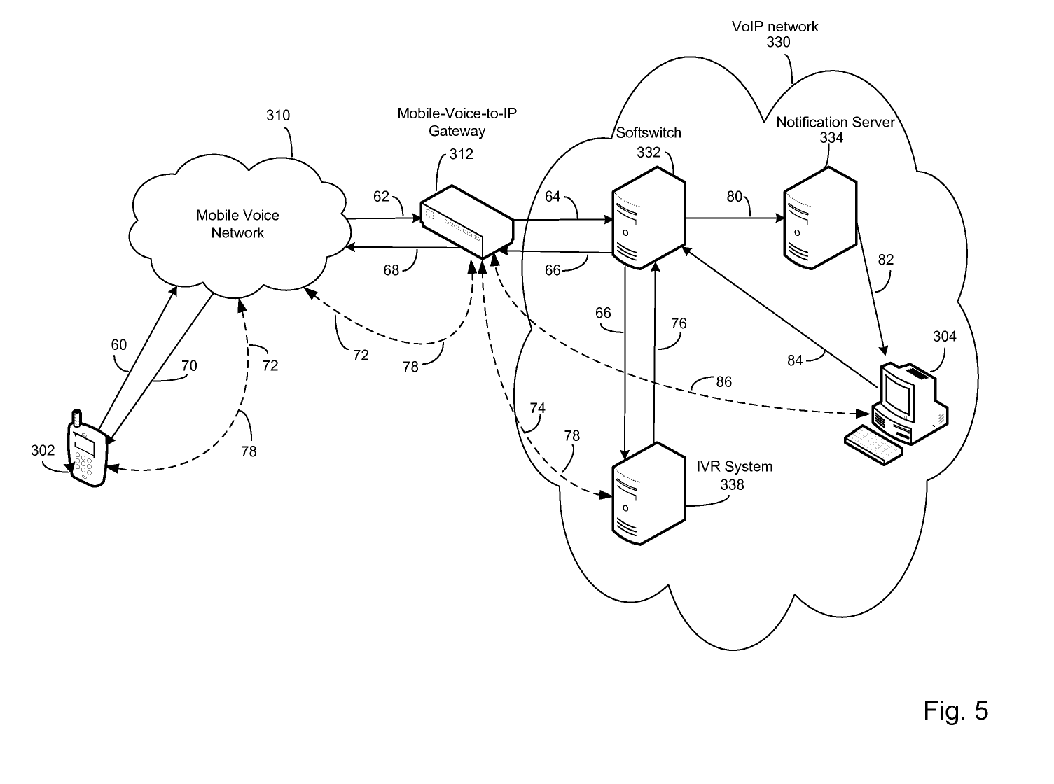

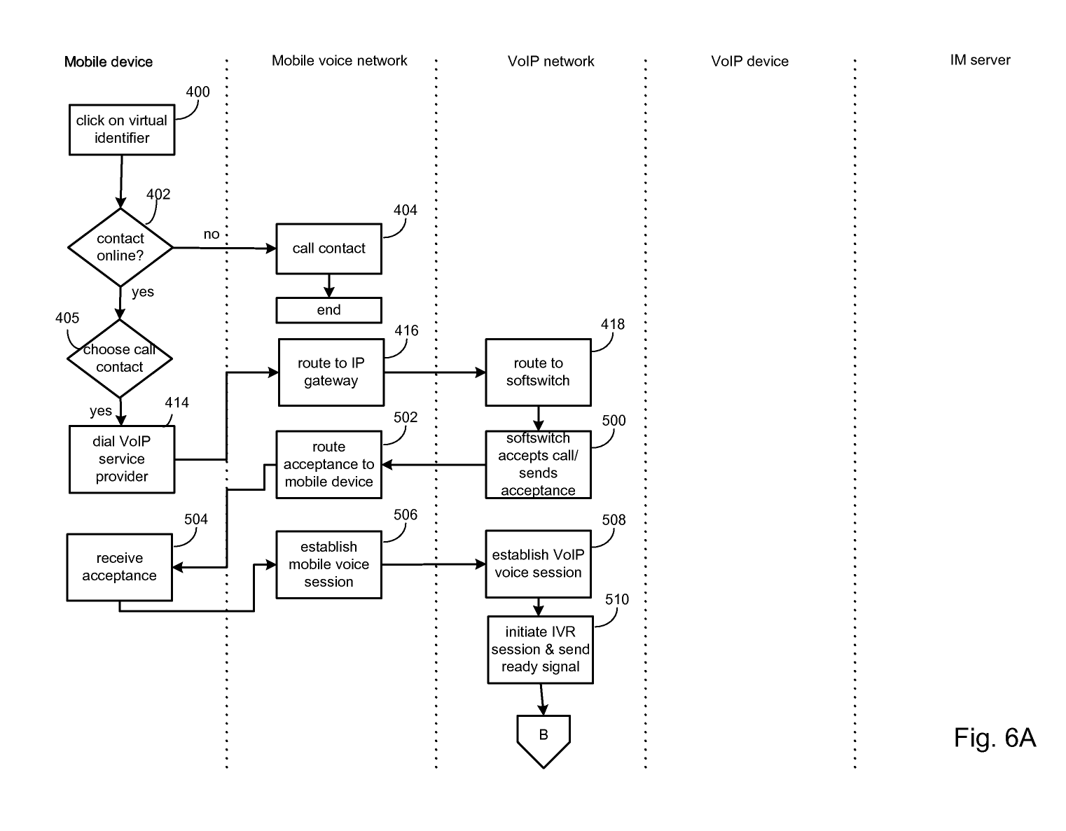

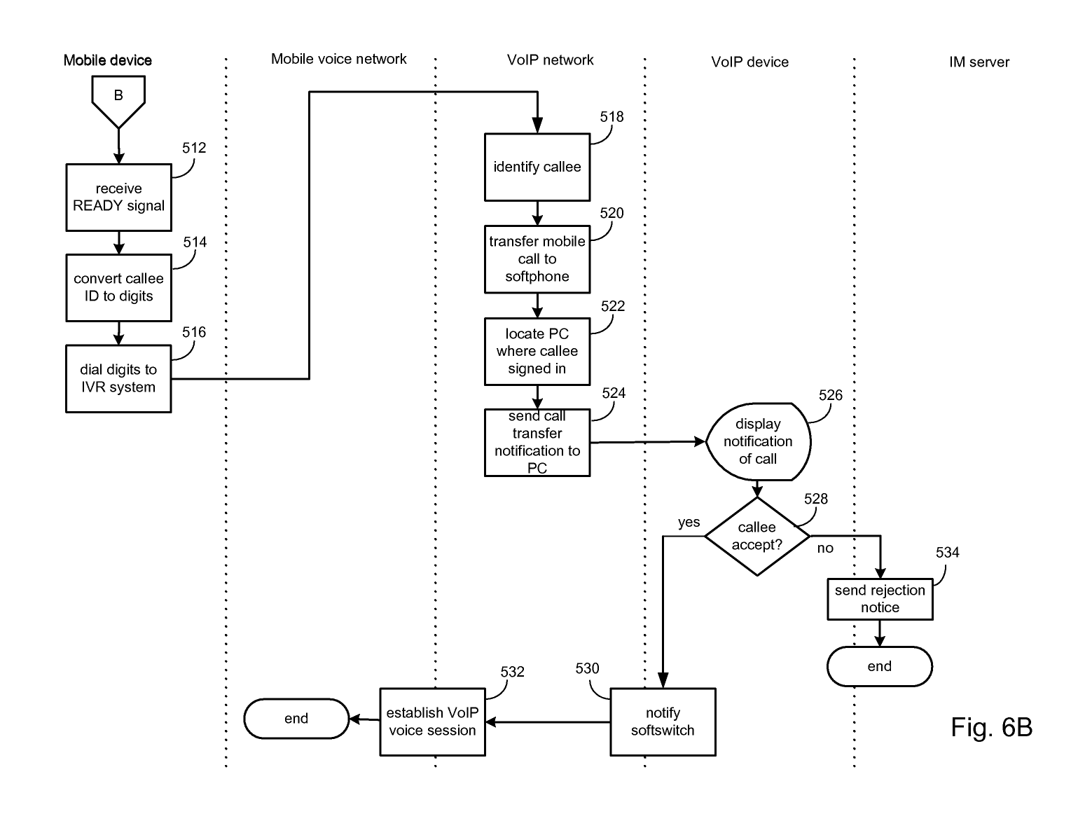

FIG. 5 illustrates another embodiment of a communications system that allows a mobile device to establish a hybrid voice connection with a VoIP device. As in the first embodiment, the mobile voice network 310 is coupled to a VoIP network 330 by a gateway device 312, and the gateway device 312 is coupled to softswitch 332 of VoIP network 330. The softswitch 332 is coupled to notification server 334, as well as to a third server 338. The third server is a conventional computing device configured to act as an interactive voice response (“IVR”) system, as described with reference to FIGS. 6A and 6B below. As before, all three servers 332, 334, and 338 could be implemented in a single computing device providing all three functions. PC 304 is coupled to and part of the VoIP network 330. This embodiment does not utilize a mobile data network.

Referring now to FIGS. 6A and 6B, a flow chart illustrates a method of establishing a voice session that is initiated by the caller on cellular telephone 302 to the callee on PC 304. Some steps are the same as the method disclosed in FIGS. 4A-4B and are numbered the same. In step 400, the caller opens the address book on cell phone 304, locates the contact listing for the callee, and clicks on the virtual identifier provided for callee.

In step 402, the online status of the callee is polled by the IM client on cell phone 302, or pushed from the IM presence server. If the contact is offline, the IM client causes cell phone 302 to call the contact directly in step 404 using the mobile voice network. If the presence indicator indicates that the callee is online, then in one embodiment, the IM client displays a pop-up screen on cell phone 302 that lists choices for IM services for the caller to select from, namely: (i) chat with contact; (ii) email contact; and (iii) call contact. If the caller selects the choice “call contact” in step 405, then in step 414, the IM client dials the telephone number for the VoIP service provider through the mobile voice network 310. This is shown by signal path 60 in FIG. 5. In step 416, the call is routed from the mobile voice network 310 to the gateway 312 (signal path 62). In step 418, the call is routed from the gateway 312 to the softswitch 332 (signal path 64) since the target telephone number is a VoIP service number.

In step 500, the softswitch 332 accepts the call and sends notice of acceptance to the gateway 312 and to the IVR server 338 (signal path 66). The gateway 312 then forwards the acceptance to the mobile voice network 330 (signal path 68) in step 502. In step 504, cell phone 302 receives the acceptance (signal path 70), and a mobile voice session (voice media path 72) is established with the gateway 312 through the mobile voice network 330 in step 506. In step 508, a VoIP voice session is established (voice media path 74) between the gateway 312 and the IVR server 338. Thus, a hybrid voice session (voice media path 78) is established between the cell phone 302 and the IVR system 338 using the mobile voice session and the VoIP voice session.

IVR is a well known technique that uses a computerized system, such as IVR server 338, to present a telephone caller with one or more options from a list of options. Generally, when a user calls an IVR system, a voice recording is played, and the caller responds by either pressing one or more numbers on the telephone keypad to select the desired option, or speaking a simple statement. The system may be configured to recognize a variety of commands in response to the voice prompts, including simple statements such as “yes” or “no,” as well as more complex statements, for example, a command plus an argument, such “call John Doe.”.

In one embodiment, softswitch 332 initiates an IVR session (signal path 76) in step 510 and sends a “ready” signal back to cell phone 302. The ready signal is preferably a voice prompt from the IVR server 338, such as “THE CALL MANAGEMENT SYSTEM IS READY. PLEASE ENTER THE PERSONAL IDENTIFICATION NUMBER FOR THE PARTY YOU ARE CALLING, THEN PRESS POUND.”

Upon receiving the ready signal in step 512, the IM client on cell phone 302 converts the callee's virtual identifier to a series of digits, then displays a pop-up screen in step 514 allowing the caller to confirm or edit the digits before sending them to the IVR system. The caller then accepts the digits, and the IM client causes the cell phone 302 to dial those digits to the IVR server 338 (voice media path 78) in step 516.

The softswitch 332 locates the callee by looking up the callee's virtual identifier in the softswitch database in step 518. The softswitch 332 then begins to transfer the mobile call through the notification server 334 (signal path 80) in step 520. The notification server locates the PC where the callee has logged in with his virtual identifier in step 522, then sends a call transfer notification to the VoIP softphone on PC 304 in step 524 (signal path 82). The notification is displayed on PC 304 in step 526 and indicates at least that a voice session is being requested by a caller, by displaying the virtual identifier of the caller or the caller ID of the cell phone 302.

If the callee accepts the call in step 528, then the softphone in PC 304 sends notice of acceptance to the softswitch server 336 in step 530 (signal path 84). In step 532, the gateway 312 establishes a VoIP voice session (voice media path 86) between the gateway 312 and the PC 304 through the VoIP network 350. Thus, a hybrid voice session is established between cell phone 302 and PC 304 using the mobile voice session (voice media path 78) and the VoIP voice session (voice media path 86). If the callee rejects the call in step 528, then a “call rejected” notification is sent back to the mobile phone 302 in step 534.

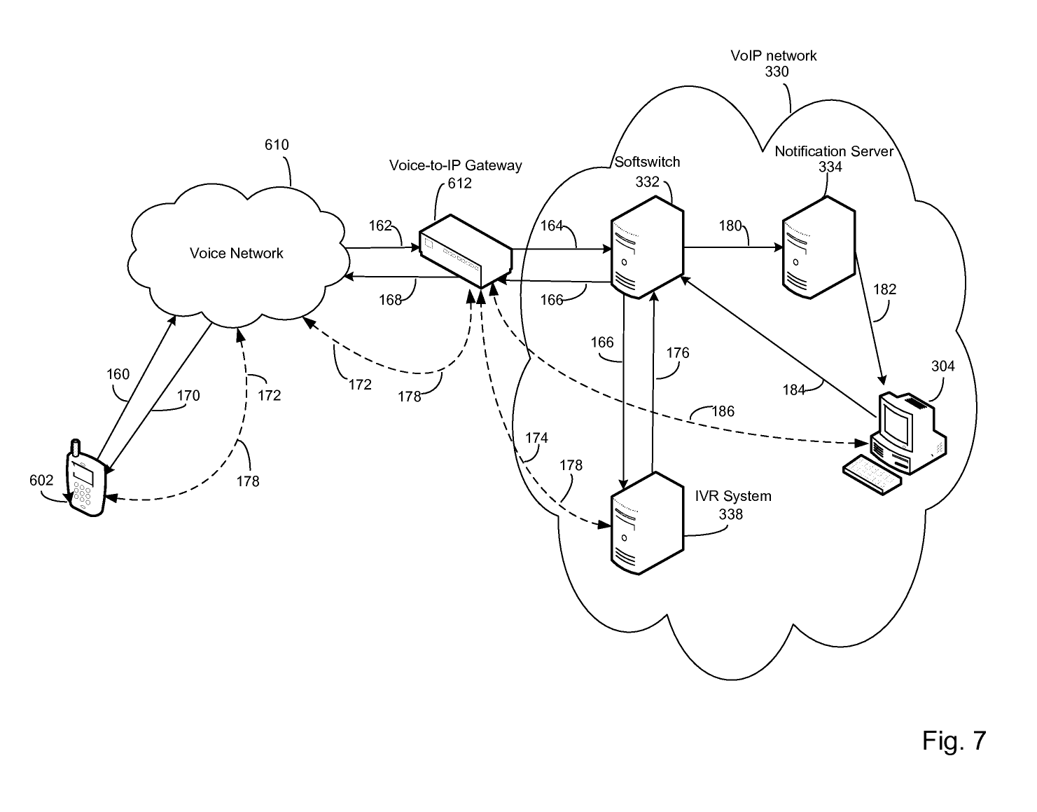

FIG. 7 illustrates another embodiment of a communications system that allows a telephone device to establish a hybrid voice connection with a VoIP device. A telephone 602 is coupled to voice network 610. The telephone and corresponding voice network may be any common telephone/network configuration, including mobile, satellite, cordless, or landline. A gateway device 612 couples the voice network 610 to softswitch 332 of VoIP network 330. The gateway device 612 is a conventional computing device that is configured to provide a communication interface between voice network 610 and IP network 330, and includes all routines necessary for managing the interface, including compression/decompression, packetization, call routing, and control signaling, for example. As in FIG. 5, the softswitch 332 is coupled to notification server 334 and IVR server 338. In this embodiment, IVR server 338 is configured with additional routines to handle incoming requests that are directly dialed from a telephone rather than being initiated from an IM client on a mobile device.

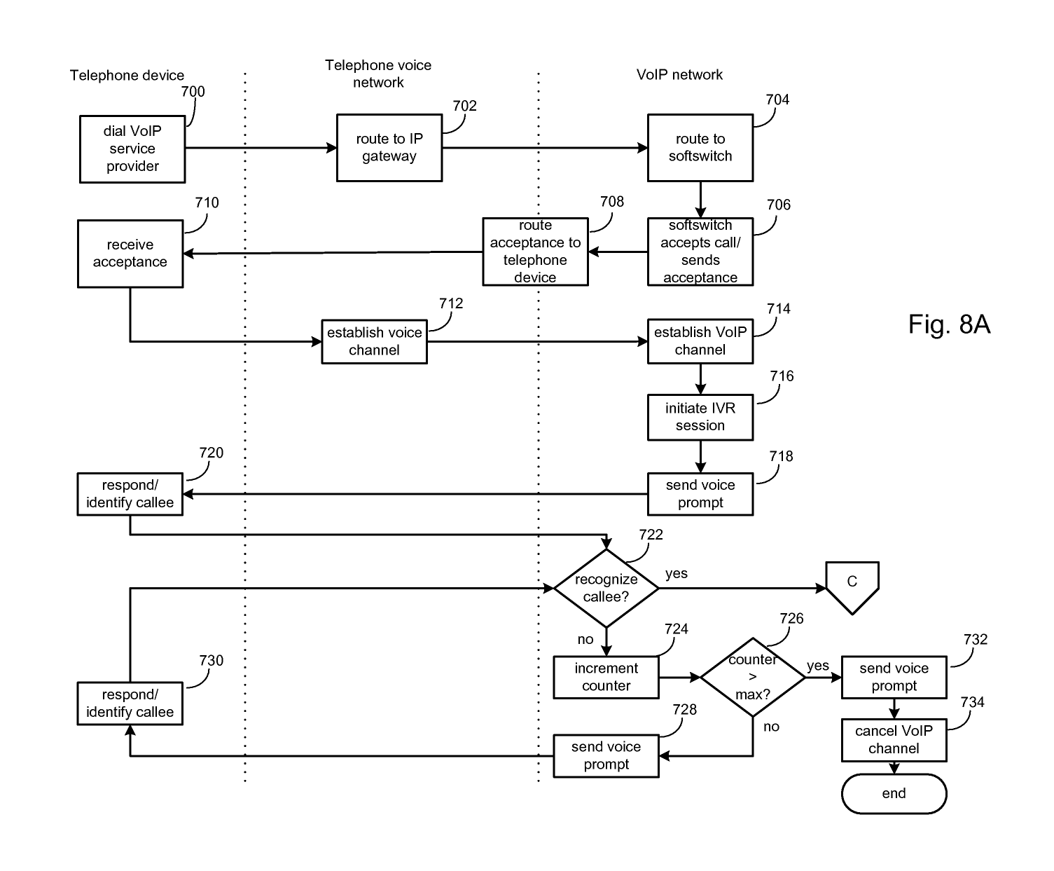

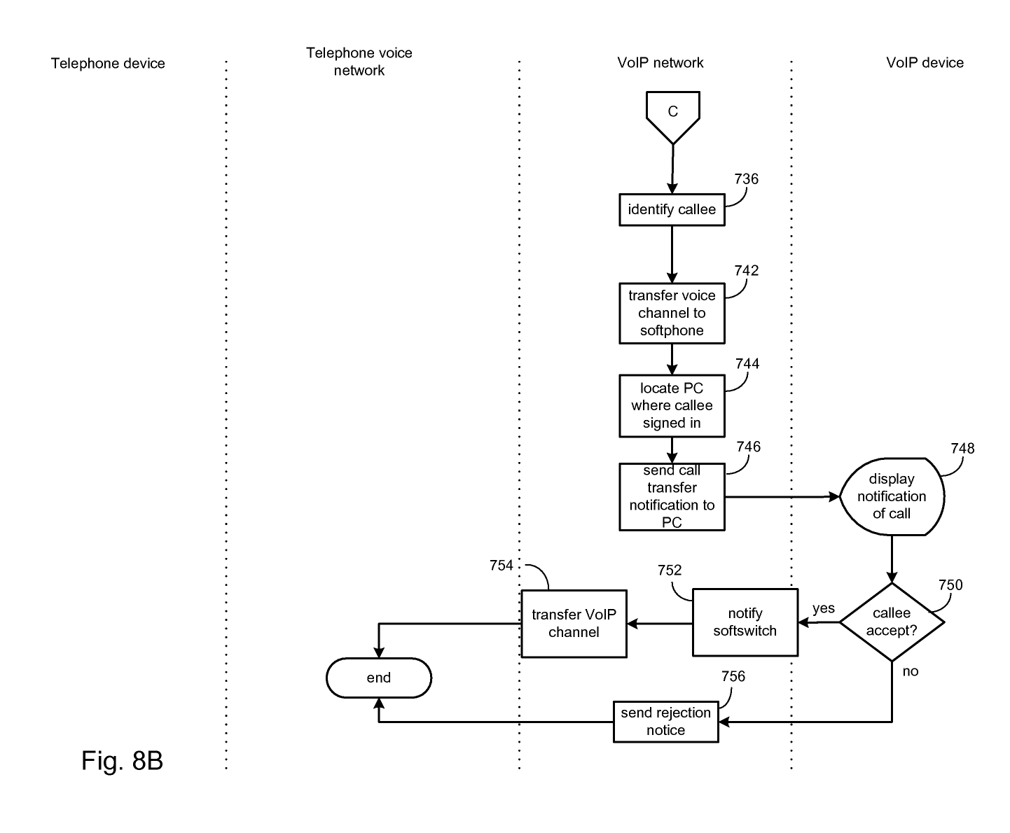

Referring now to FIG. 8, a flow chart illustrates a method of establishing a hybrid voice session that is initiated by the caller on telephone 602 to the callee on PC 304. In step 700, the caller dials the telephone number for the VoIP service provider through the voice network 610 (signal path 160 in FIG. 7). In step 702, the call is routed from the voice network 610 to the gateway 612 (signal path 162). In step 704, the call is routed from the gateway 612 to softswitch 332 (signal path 164) since the dialed telephone number is a service number for the VoIP network.

In step 706, the softswitch 332 accepts the call and sends notice of acceptance to the gateway 612 and to the IVR server 338 (signal path 166). In step 708, the gateway 612 forwards the acceptance to the voice network 610 (signal path 168). In step 710, telephone 602 receives the acceptance (signal path 170), and a voice channel (voice media path 172) is then established with the gateway 612 through the voice network 630 in step 712. In step 714, a VoIP channel is established (voice media path 174) between the gateway 612 and the IVR server 338. Thus, a hybrid voice session (voice media path 178) is established between the telephone 602 and the IVR system 338 using the voice channel and the VoIP channel.

Softswitch 332 then initiates an IVR session (signal path 176) in step 716 and causes the IVR server 338 to send a first voice prompt back to telephone 602 in step 718. The voice prompt is preferably a simple message, such as “THE CALL MANAGEMENT SYSTEM IS READY. PLEASE STATE YOUR REQUEST.” The caller responds with a voice command including an argument in step 720, for example: “CALL JOHN DOE AT HOTMAIL DOT COM,” or simply: “CALL JOHN DOE.” If the IVR system 338 does not recognizes the callee or understand the command in step 722, then it increments a counter in step 724.

In step 726, if the counter does not exceed a present maximum for number of tries, such as three, then the IVR system issues a voice prompt in step 728 such as: “I DO NOT UNDERSTAND YOUR COMMAND. PLEASE TRY AGAIN.” In step 730, the caller tries again to speak a proper response.

If the counter does exceed the present maximum in step 726, then the IVR system issues a voice prompt in step 732 such as: “I'M SORRY THAT YOU'RE HAVING DIFFICULTY. PLEASE TRY AGAIN LATER” and the softswitch cancels the VoIP voice session and ends the routine in step 734.

If the IVR system does understand the command and recognizes the callee in step 722, then the softswitch 332 locates the callee on the VoIP network by looking up the identifier provided by the caller in the softswitch database in step 736.

The softswitch 332 then begins to transfer the voice session through the notification server 334 (signal path 180) in step 742. The notification server locates the PC where the callee has logged in with his virtual identifier in step 744, then sends a call transfer notification to the VoIP softphone on PC 304 in step 746 (signal path 182). The notification is displayed on PC 304 in step 748 and indicates at least that a voice session is being requested by a caller, by displaying the virtual identifier of the caller or the caller ID of the cell phone 302.

If the callee accepts the call in step 750, then the softphone in PC 304 sends notice of acceptance to the softswitch server 336 in step 752 (signal path 184). In step 754, the gateway 612 establishes a VoIP channel (voice media path 186) between the gateway 612 and the PC 304 through the VoIP network 330. Thus, a hybrid voice session is established between telephone 602 and PC 304 using the voice channel (voice media path 178) and the VoIP channel (voice media path 186). If the callee rejects the call in step 750, then the IVR system sends a voice notification statement to telephone 602 in step 756, such as: “THE PERSON YOU ARE CALLING CANNOT ANSWER THE CALL AT THIS MOMENT” and the routine ends.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. It is intended that the scope of the invention be defined by the claims appended hereto.

We claim:

1. A method for establishing a voice session between a mobile device and a VoIP device, comprising:
receiving a request from a caller using a mobile device through a mobile voice network to initiate a voice session with a callee using a VoIP device;
determining if the callee is online;
notifying the callee at the VoIP device regarding the voice session;
establishing the voice session via a mobile voice channel and a VoIP voice channel if the voice session is accepted by the callee.

2. The method of claim 1, the method further comprising:
creating a call registration record based on the request, the record including at least a virtual identifier associated with the callee, and a device identifier associated with the mobile device.

3. The method of claim 2, further comprising:
receiving a telephone call from the mobile device through the mobile voice network, said call including the device identifier for the mobile device; and
retrieving the call registration record based on the device identifier for the mobile device.

4. The method of claim 1, further comprising:
coupling the caller to an IVR system; and
establishing a VoIP voice channel through the VoIP network between a gateway and the IVR system.

5. The method of claim 4, further comprising:
sending a ready signal from the IVR system to the mobile device; and
receiving a personal identifier from the mobile device corresponding to a virtual identifier associated with the callee.

6. A method for establishing a voice session between a mobile device and a VoIP device, comprising:
receiving a request from a caller using a mobile device through a mobile data network to initiate a voice session with a callee using a VoIP device, the request including at least a virtual identifier associated with the callee, and a device identifier associated with the mobile device;
creating a call registration record based on the request;
receiving a telephone call from the mobile device through a mobile voice network, said telephone call including the device identifier for the mobile device;
retrieving the call registration record based on the device identifier for the mobile device;
notifying a VoIP device coupled to a VoIP network and having the virtual identifier associated with the callee regarding the voice session; and
establishing the voice session via a mobile voice channel and a VoIP voice channel if the voice session is accepted by the callee.

7. The method of claim 6, wherein the request is initiated when the caller selects the virtual identifier associated with the callee from a list of contacts stored on the mobile device.

8. The method of claim 6, wherein the request further includes a virtual identifier associated with the caller.

9. The method of claim 6, wherein the request further includes an expiration time for the call registration record.

10. The method of claim 6, wherein the mobile device and the VoIP device each include an instant messenger client application that maintains a list of contacts which are personal to the user, including virtual identifiers, and wherein the step of receiving a request is initiated when a caller selects a contact from the contact list.

11. The method of claim 10, further comprising polling the virtual identifier associated with the callee to confirm that the callee is online prior to establishing the call registration record.

12. The method of claim 11, further comprising establishing a voice session with the callee through the mobile voice network if the callee is offline.

13. The method of claim 6, wherein the step of receiving a telephone call includes receiving a personal identifier that corresponds to the virtual identifier associated with the callee.

14. The method of claim 6, wherein the notifying step comprises displaying a notice on the VoIP device.

15. The method of claim 14, wherein the notice includes the virtual identifier of the caller and the device identification of the mobile device.

16. A method for establishing a voice session between a telephone device and a VoIP device, comprising:
receiving a telephone call from a telephone device through a telephone voice network;
establishing a voice channel through the telephone voice network between the telephone device and a gateway;
establishing a VoIP channel through a VoIP network between the gateway and an IVR system;
sending a first voice prompt from the IVR system to the telephone device;
receiving a response to the first voice prompt that identifies a callee for a proposed voice session; sending a second voice prompt from the IVR system to the telephone device asking for a personal identifier associated with the callee;
receiving a response to the second voice prompt that includes the personal identifier;
notifying the callee regarding the voice session; and
establishing a VoIP channel through the VoIP network between the gateway and the VoIP device.

17. The method of claim 16, wherein the notifying step comprises prompting the callee to accept or reject the voice session.

18. The method of claim 17, further comprising determining whether the callee has accepted or rejected the voice session prior to establishing the VoIP channel between the gateway and the VoIP device.

19. The method of claim 17, wherein the notifying step includes identifying the caller to the callee.

20. The method of claim 16, wherein the step of establishing the VoIP channel between the gateway and the VoIP device comprises transferring the VoIP channel that is established between the gateway and the IVR system.
